(19) United States
(12) Patent Application Publication
(10) Pub. No.: US 2013/0180374 A1
(43) Pub. Date: Jul. 18, 2013

(54) CUTTING APPARATUS AND COMPUTER-READABLE STORAGE MEDIUM STORING PROGRAM FOR USE WITH THE CUTTING APPARATUS

(71) Applicant: BROTHER KOGYO KABUSHIKI KAISHA, Nagoya-shi (JP)

(72) Inventors: Daisuke Abe, Nagoya-shi (JP); Yasuhiko Kawaguchi, Nagoya-shi (JP); Yoshinori Nakamura, Nagoya-shi (JP); Mitsuhiro Iida, Nagoya-shi (JP); Masashi Tokura, Nagoya-shi (JP)

(73) Assignee: BROTHER KOGYO KABUSHIKI KAISHA, Nagoya-shi (JP)

(21) Appl. No.: 13/726,862

(22) Filed: Dec. 26, 2012

(30) Foreign Application Priority Data
Jan. 16, 2012 (JP) 2012-006122

(51) Int. Cl. B26D 5/00

(52) U.S. Cl. CPC B26D 5/00
USPC 83/76.8

(57) ABSTRACT

A cutting apparatus includes a cutting unit configured to move a holding member set on the cutting apparatus and a cutting blade relative to each other thereby to cut a desired pattern out of at least one object to be cut, by the cutting blade, the holding member holding the object so that the object is removable therefrom, a detection unit configured to detect information including a hold position of the object held by the holding member, a pattern selecting unit configured to select a desirable one of a plurality of patterns, and an arrangement unit which sets an arrangement position of the pattern selected by the pattern selecting unit, relative to the object, based on the detected hold position of the object. The pattern is cut off by the cutting unit with the arrangement position set by the arrangement unit serving as a cutting position of the object.

### CROSS-REFERENCE TO RELATED APPLICATIONS

This application is based upon and claims the benefit of priority from the prior Japanese Patent Application No. 2012-6122 filed on Jan. 16, 2012, the entire contents of which are incorporated herein by reference.

### BACKGROUND

1. Technical Field

The present disclosure relates to a cutting apparatus in which a desirable pattern is cut out of an object to be cut by a cutting blade, and a computer-readable storage medium storing a program for use with the cutting apparatus.

2. Related Art

There has conventionally been known a cutting plotter which automatically cuts a sheet such as paper, for example. The sheet is affixed to a base material serving as a holding member having an adhesive layer on a surface thereof. The cutting plotter includes a drive mechanism having a driving roller and a pinch roller both of which are vertically disposed and hold both ends of the base material therebetween so that the object is moved in a first direction. The cutting apparatus also includes a carriage which has a cutting blade and is moved in a second direction perpendicular to the first direction, whereby a desirable pattern is cut out of the sheet.

When a relatively smaller pattern is to be cut by the cutting plotter, the size of the sheet may also be smaller. In this case, a user cuts the sheet with scissors to obtain a sheet size according to a pattern and thereafter affixes the sheet to the base material. Alternatively, the user prepares a relatively smaller stock sheet and affixes the sheet to the base material. There is a possibility that a cutting line of the pattern may run off the sheet when a location and an angle of the sheet affixed to the base material are improper even if the prepared sheet has a size suitable for the pattern. More specifically, the cutting plotter executes cutting without control of the location and the angle of the sheet affixed to the base material. As a result, the pattern cannot be cut out of the sheet according to circumstances, whereupon the sheet is wasted.

### SUMMARY

Therefore, an object of the disclosure is to provide a cutting apparatus which can automatically set a position of the pattern according to at least one object to be cut, held on a holding member, and a computer-readable storage medium which stores a program for use with the cutting apparatus.

The present disclosure provides a cutting apparatus comprising a cutting unit which is configured to move a holding member set on the cutting apparatus and a cutting blade relative to each other thereby to cut a desired pattern out of at least one object to be cut, by the cutting blade, the holding member holding the object so that the object is removable therefrom; a detection unit which is configured to detect information including a hold position of the object held by the holding member; a pattern selecting unit which is configured to select a desirable one of a plurality of patterns; an arrangement unit which sets an arrangement position of the pattern selected by the pattern selecting unit, relative to the object, based on the hold position of the object detected by the detection unit, wherein the pattern is cut off by the cutting unit with the arrangement position set by the arrangement unit serving as a cutting position of the object.

The disclosure also provides a non-transitory computer readable storage medium which stores a program used with a cutting apparatus including a cutting unit which is configured to move a holding member set on the cutting apparatus and a cutting blade relative to each other thereby to out a desired pattern out of at least one object to be cut, by the cutting blade, the holding member holding the object so that the object is removable therefrom. The program comprises a detection routine of detecting information including a hold position of the object held by the holding member and an arrangement routine of setting an arrangement position of the pattern selected by the pattern selecting unit, relative to the object, based on the hold position of the object detected by the detection routine.

### BRIEF DESCRIPTION OF THE DRAWINGS

In the accompanying drawings:

FIG. 1 is a perspective view of the cutting apparatus according to one embodiment, showing an inner structure thereof;

FIG. 2 is a plan view of the cutting apparatus;

FIG. 3 is a perspective view of a cutter holder;

FIG. 4 is a sectional view of the cutter holder, showing the case where the cutter has been ascended;

FIG. 5 is a side view of the cutter holder and its vicinity, showing the case where the cuter has been descended;

FIG. 6 is an enlarged front view of a gear;

FIG. 7 is an enlarged view of a distal end of the cutter and its vicinity during cutting;

FIG. 8 is a block diagram showing an electrical arrangement of the cutting apparatus;

FIG. 9A shows a data structure of detection color data of the object;

FIG. 9B shows an outline extracted from the image data of the object;

FIG. 9C shows the outline of the object and the position of the pattern to be placed;

FIG. 10A shows a data structure of cutting data of a pattern and color data;

FIG. 10B is a view explaining cutting data of the pattern;

FIGS. 11A and 11B shows examples of pattern selecting screens classified on the basis of color data;

FIG. 12 shows an example of arrangement display screen;

FIG. 13 is a flowchart showing a process of setting an arrangement position of the pattern;

FIG. 14 is a view similar to FIG. 13, showing the case where an object is firstly selected and an arrangement position is then set in a second embodiment; and

FIG. 15 is a view similar to FIG. 11A, showing the pattern selected based on color data.

### DETAILED DESCRIPTION

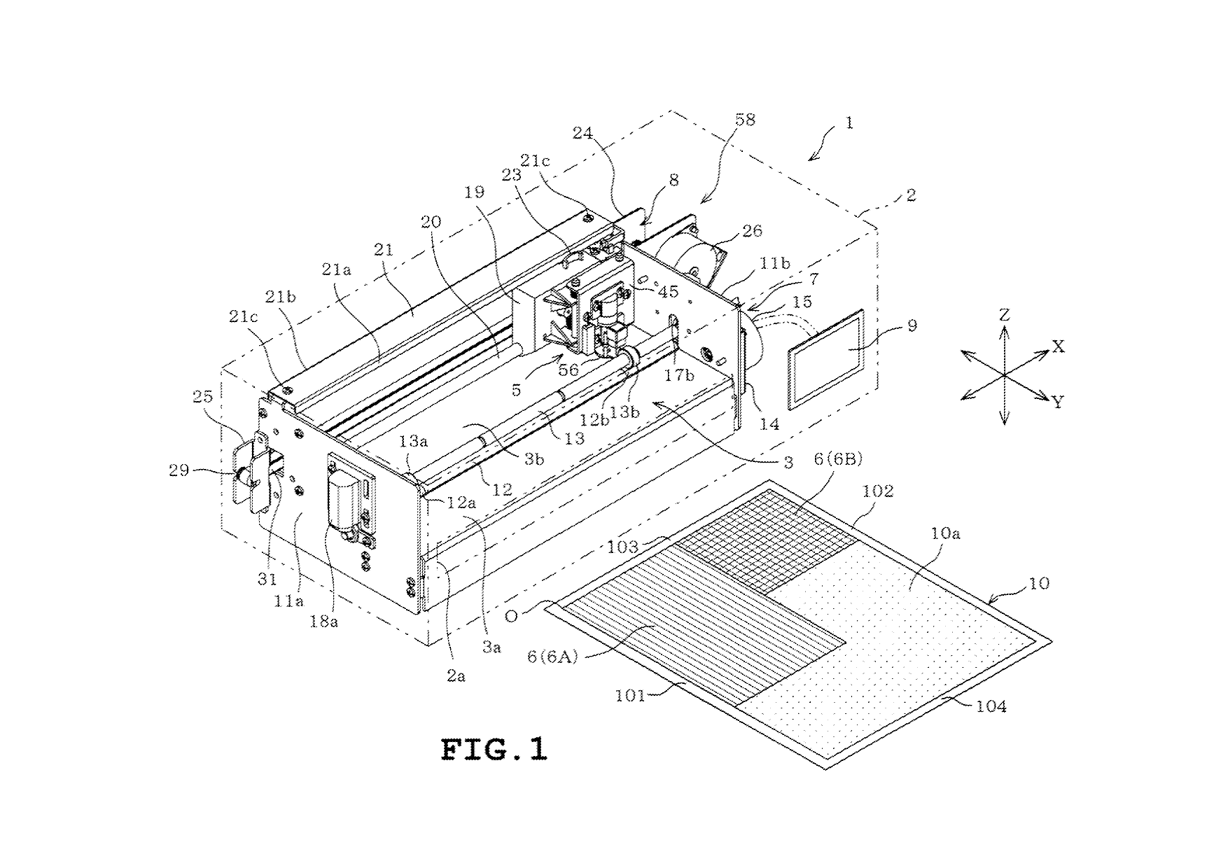

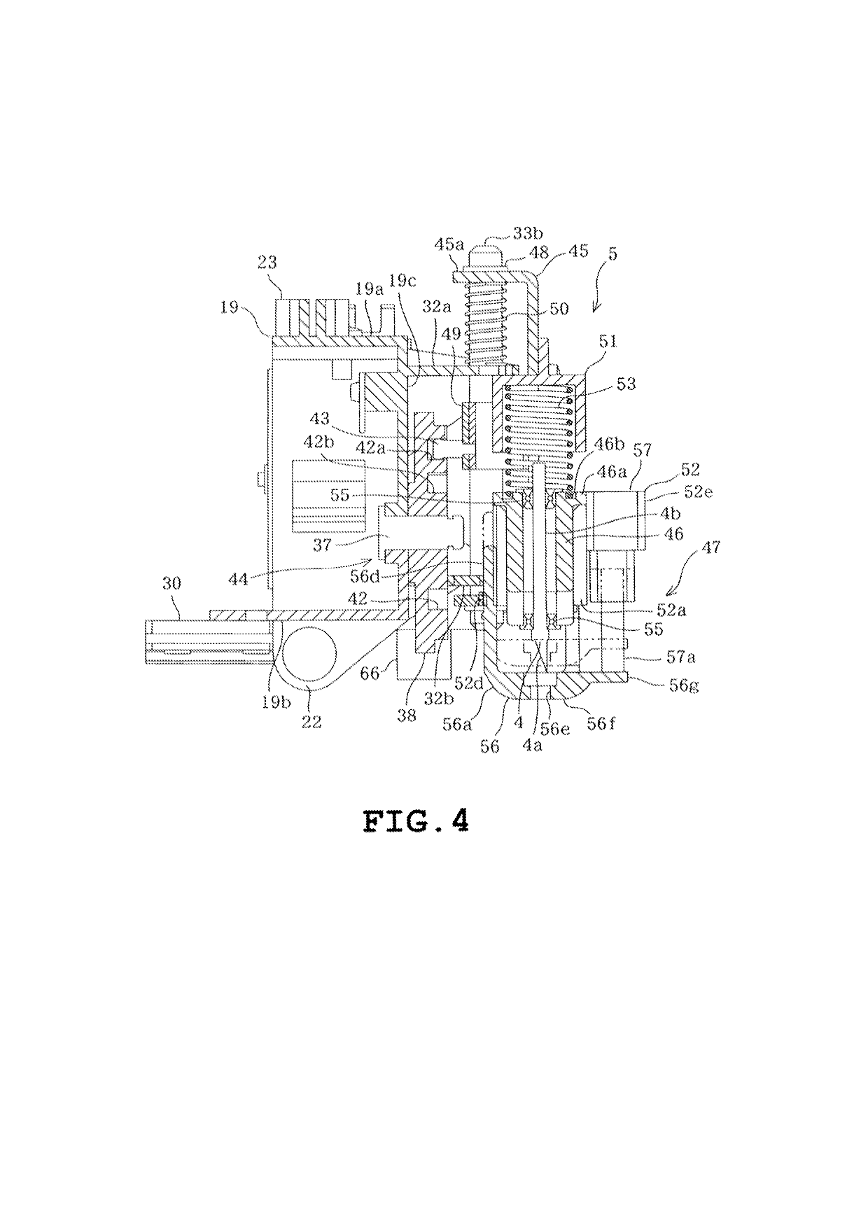

A first embodiment will be described with reference to FIGS. 1 to 13. Referring to FIG. 1, a cutting apparatus 1 includes a body cover 2 as a housing, a platen 3 provided in the body cover 2 and a cutter holder 5 also provided in the body cover 2. The cutting apparatus 1 also includes first and second moving units 7 and 8 for moving a cutter 4 (see FIG. 4) of the cutter holder 5 and an object 6 to be cut, relative to each other. The body cover 2 is formed into the shape of a horizontally long rectangular box and has a front formed with a horizontally long opening 2a which is provided for setting a holding sheet 10 holding the object 6. In the following description, a direction in which the object 6 is moved by the first moving unit 7 will be referred to as “front-back direction” and more specifically, the side of the cutting apparatus 1 where the opening 2a is located will be referred to as “front” and the opposite side will be referred to as “back.” The front-back direction will be referred to as “Y direction.” The right-left direction perpendicular to the Y direction will be referred to as “X direction.”

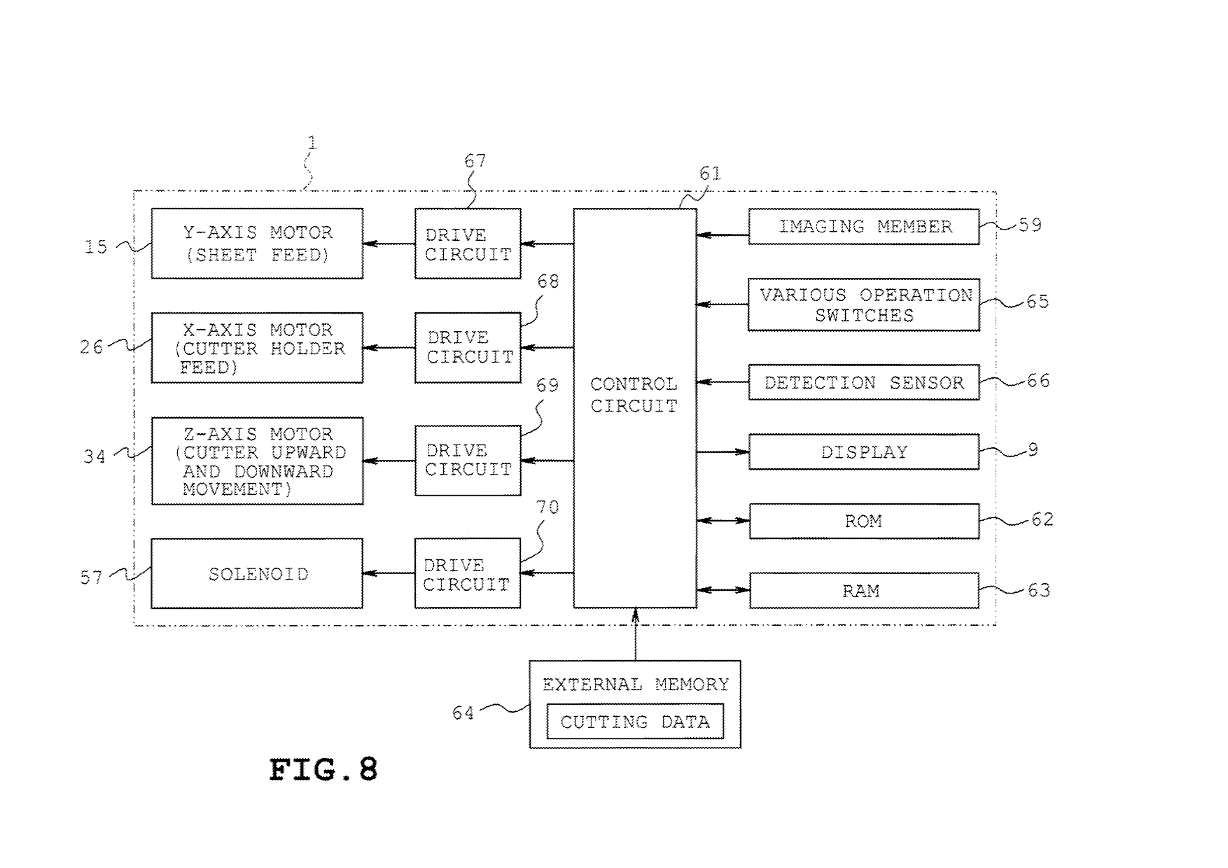

On a right part of the body cover 2 are provided a liquid crystal display (LCD) 9 and a plurality of operation switches 65 (see FIG. 8). The LCD 9 serves as a display unit displaying messages and the like necessary for the user. The operation switches 65 serve as input units for the user to supply various instructions, selections and inputs to the cutting apparatus 1. Operation of the operation switches 65 realizes selection of a pattern displayed on the LCD 9, set of various parameters, instruction of functions and the like.

The platen 3 includes a pair of front and rear plate members 3a and 3b and has an upper surface which is configured into an X-Y plane serving as a horizontal plane. The platen 3 is set so that the holding sheet 10 holding the object 6 is placed thereon. The holding sheet 10 is received by the platen 3 when the object 6 is cut. The holding sheet 10 has an upper surface with an adhesive layer 10a formed by applying an adhesive agent to a part thereof except for peripheral edges 101 to 104 as will be described in detail later. The user affixes the object 6 to the adhesive layer 10a, whereby the object 6 is held by the holding sheet 10.

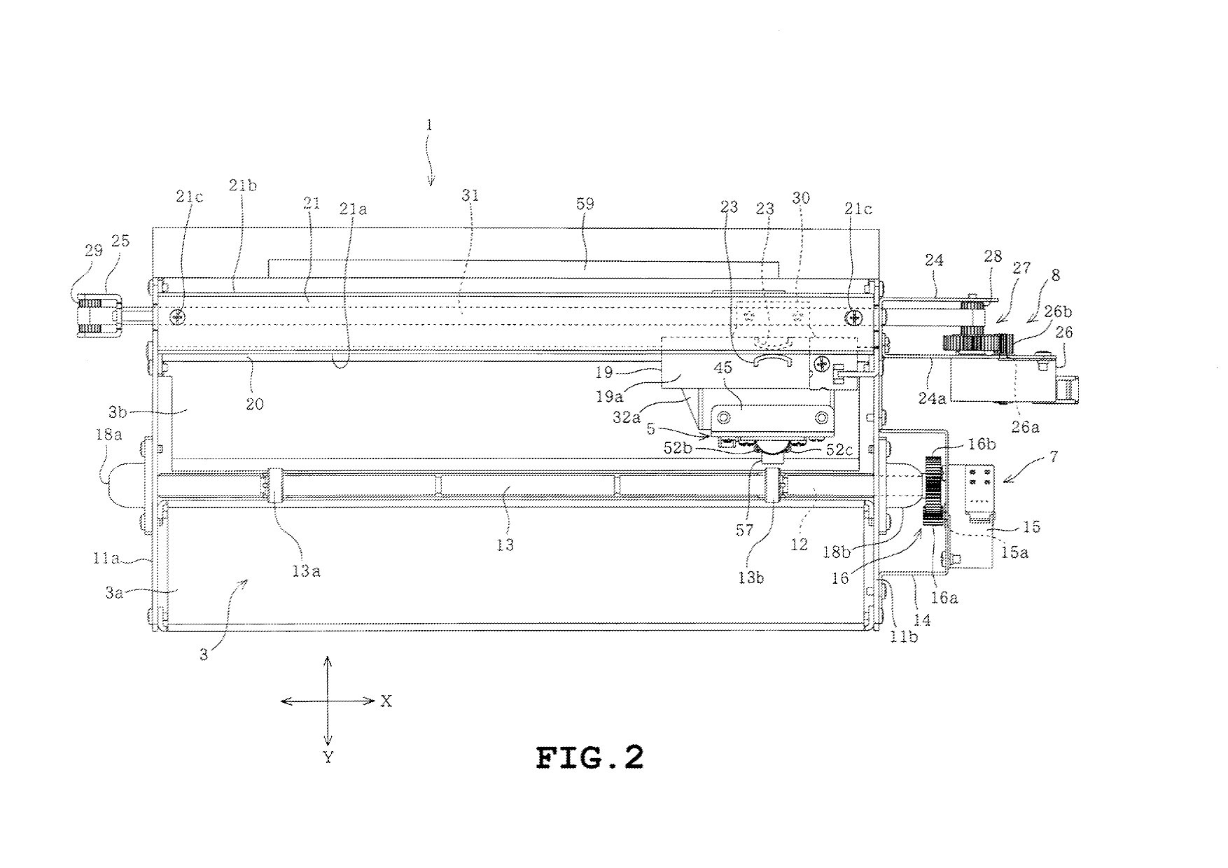

The first moving unit 7 moves the holding sheet 10 on the upper surface side of the platen 3 in the Y direction (a first direction). More specifically, a driving roller 12 and a pinch roller 13 are provided on right and left sidewalls 11b and 11a so as to be located between plate members 3a and 3b of the platen 3 respectively. The driving roller 12 and the pinch roller 13 extend in the X direction and are rotatably supported on the sidewalls 11b and 11a. The driving roller 12 and the pinch roller 13 are disposed so as to be parallel to a horizontal plane and so as to be vertically arranged. The driving roller 12 is located under the pinch roller 13. A first crank-shaped mounting frame 14 is mounted on the right sidewall 11b so as to be located on the right of the driving roller 12 as shown in FIG. 2. A Y-axis motor 15 is fixed to an outer surface of the mounting frame 14.

A stepping motor is used as the Y-axis motor 15, for example. The Y-axis motor 15 has a rotating shaft 15a extending through a hole (not shown) of the first mounting frame 14 and further has a distal end provided with a gear 16a. The driving roller 12 has a right end to which is secured another gear 16b which is brought into mesh engagement with the gear 16a. These gears 16a and 16b constitute a first reduction gear mechanism 16. The pinch roller 13 is guided by guide grooves 17b formed in the right and left sidewalls 11b and 11a so as to be movable upward and downward. Only the right guide groove 17b is shown in FIG. 1. Two spring accommodating members 18a and 18b are mounted on the right and left sidewalls 11b and 11a in order to cover the guide groove 17b from the outside respectively. The pinch roller 13 is biased downward by compression coil springs (not shown) accommodated in the spring accommodating portions 18a and 18b respectively. The pinch roller 13 is provided with pressing portions 13a and 13b which are brought into contact with both right and left edges 101 and 102 of the holding sheet 10, thereby pressing the edges 101 and 102, respectively. The pressing portions 13a and 13b have slightly larger outer diameters than the other portion of the pinch roller 13 respectively. The driving roller 12 is also formed with pressing portions 12a and 12b located so as to correspond to the pressing portions 13a and 13b respectively.

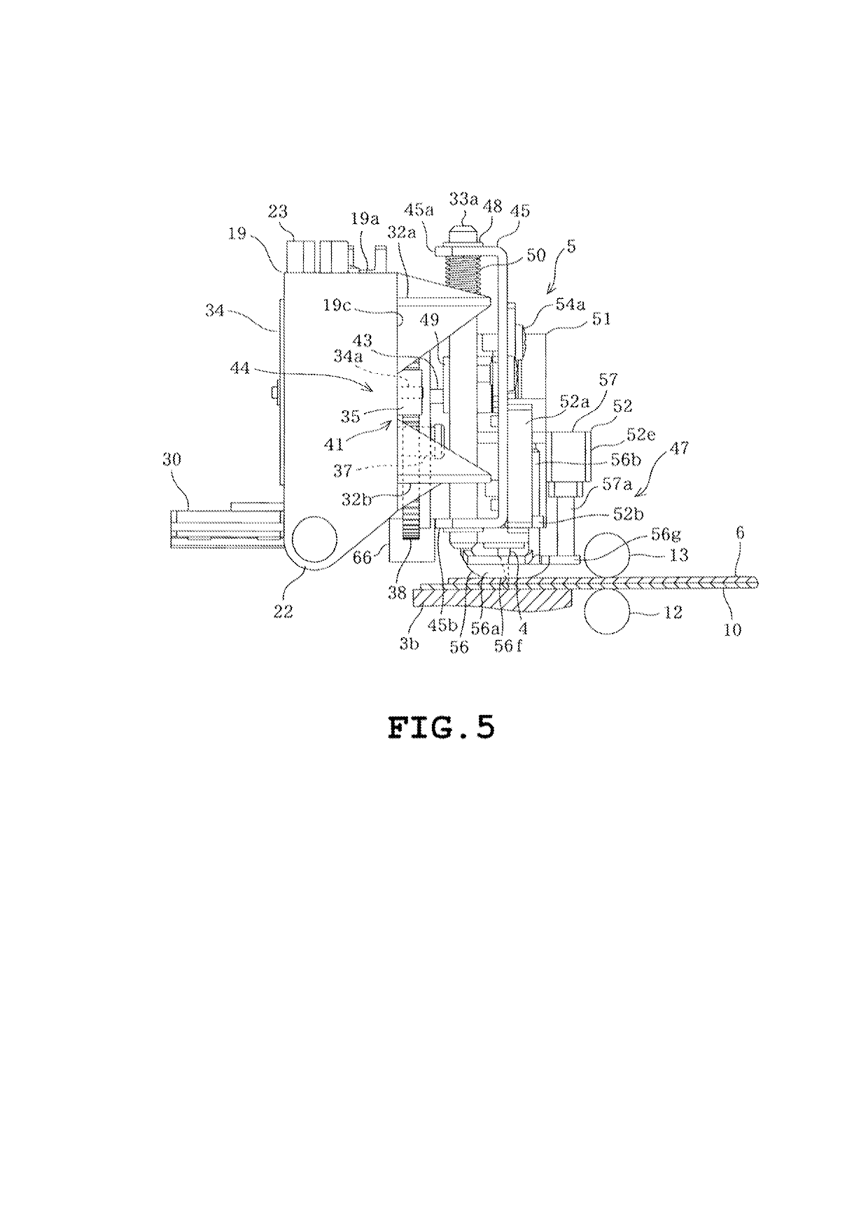

The driving roller 12 and the pinch roller 13 press the holding sheet 10 from below and from above by the biasing force of the compression coil springs thereby to hold the holding sheet 10 therebetween (see FIG. 5). Upon drive of the Y-axis motor 15, normal or reverse rotation of the Y-axis motor 15 is transmitted via the first reduction gear mechanism 16 to the driving roller 12, whereby the holding sheet 10 is moved backward or forward together with the object 6. The first moving unit 7 is thus constituted by the driving roller 12, the pinch roller 13, the Y-axis motor 15, the first reduction gear mechanism 16, the compression coil springs and the like.

The second moving unit 8 moves a carriage 19 supporting the cutter holder 5 in the X direction (a second direction). The second moving unit 8 will be described in more detail. A guide shaft 20 and a guide frame 21 both extending in the right-left direction are provided between the right and left sidewalls 11b and 11a so as to be located at the rear end of the cutting apparatus 1, as shown in FIGS. 1 and 2. The guide shaft 20 is disposed in parallel with the driving roller 12 and the pinch roller 13. The guide shaft 20 located right above the platen 3 extends through a hole of a lower part of the carriage 19 (a through hole 22 as will be described later). The guide frame 21 has a front edge 21a and a rear edge 21b both folded downward such that the guide frame 21 has a generally C-shaped section. The front edge 21a is disposed in parallel with the guide shaft 20. The guide frame 21 is adapted to guide an upper part (guided members 23 as will be described later) of the carriage 19 by the front edge 21a. The guide frame 21 is fixed to upper ends of the sidewalls 11a and 11b by screws 21c respectively.

A second mounting frame 24 is mounted on the right sidewall 11b in the rear of the cutting apparatus 1, and an auxiliary frame 25 is mounted on the left sidewall 11a in the rear of the cutting apparatus 1, as shown in FIG. 2. An X-axis motor 26 and a second reduction gear mechanism 27 are mounted on the second mounting frame 24. The X-axis motor 26 may be a stepping motor, for example and is fixed to a front of a front mounting piece 24a. The X-axis motor 26 includes a rotating shaft 26a which extends through a hole (not shown) of the mounting piece 24a and has a distal end provided with a gear 26b which is brought into mesh engagement with the second reduction gear mechanism 27. A pulley 28 is rotatably mounted on the second reduction gear mechanism 27, and another pulley 29 is rotatably mounted on the left auxiliary frame 25 as viewed in FIG. 2. An endless timing belt 31 connected to a rear end (a mounting portion 30 as will be described later) of the carriage 19 extends between the pulleys 28 and 29.

Upon drive of the X-axis motor 26, normal or reverse rotation of the X-axis motor 26 is transmitted via the second reduction gear mechanism 27 and the pulley 28 to the timing belt 31, whereby the carriage 19 is moved leftward or rightward together with the cutter holder 5. Thus, the carriage 19 and the cutter holder 5 are moved in the X direction perpendicular to the Y direction in which the object 6 is conveyed. The second moving unit 8 is constituted by the above-described guide shaft 20, the guide frame 21, the X-axis motor 26, the second reduction gear mechanism 27, the pulleys 28 and 29, the timing belt 31, the carriage 19 and the like.

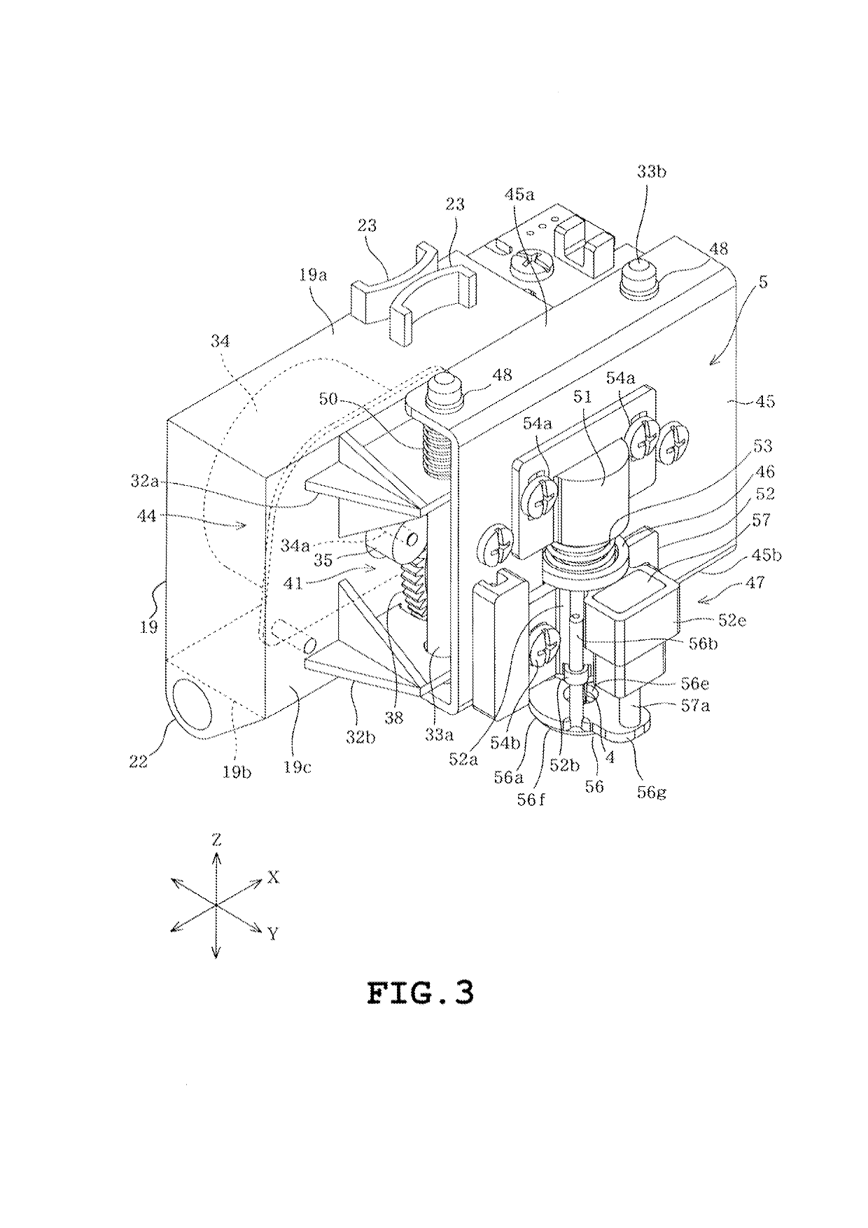

The cutter holder 5 is disposed on the front of the carriage 19 and is supported so as to be movable in a vertical direction (a third direction) serving as a Z direction. The carriage 19 and the cutter holder 5 will be described with reference to FIGS. 3 to 6 as well as FIGS. 1 and 2. The carriage 19 is formed into the shape of a substantially rectangular box with an open rear as shown in FIGS. 3 and 4. The carriage 19 has an upper wall 19a with which a pair of upwardly protruding front and rear guided members 23 are integrally formed. Each guided member 23 is an arc-shaped rib as viewed in a planar view. The guided members 23 are symmetrically disposed with a front edge 21a of the guide frame 21 being interposed therebetween. The carriage 19 has a bottom wall 19b further having a downwardly expanding portion which is formed with a pair of right and left through holes 22 through which the guide shaft 20 is inserted. An attaching portion 30 (see FIGS. 4 and 5) is mounted on the bottom wall 19b of the carriage 19 so as to protrude rearward. The attaching portion 30 is to be coupled with the timing belt 31. The carriage 19 is thus supported by the guide shaft 20 inserted through the holes 22, so as to be slidable in the right-left direction and further supported by the guide frame 21 held between the guided members 23, so as to be prevented from being rotated about the guide shaft 20.

The carriage 19 has a front wall 19c with which a pair of upper and lower support portions 32a and 32b are formed so as to extend forward as shown in FIGS. 3 to 5, etc. A pair of right and left support shafts 33b and 33a extending through the respective support portions 32b and 32a are mounted on the carriage 19 so as to be vertically movable. A Z-axis motor 34 which may be a stepping motor, for example is accommodated in the carriage 19 backward thereby to be housed therein. The Z-axis motor 34 has a rotating shaft 34a (see FIGS. 3 and 5) which extends through a hole (not shown) of the front wall 19c of the carriage 19. The rotating shaft 34a has a distal end provided with a gear 35. Furthermore, the carriage 19 is provided with a gear shaft 37 which extends through a hole (not shown) formed in a slightly lower part of the gear 35 relative to the central part of the front wall 19c as shown in FIG. 4. A gear 38 is rotatably mounted on the gear shaft 37 and adapted to be brought into mesh engagement with the gear 35 in front of the front wall 19c. The gear 37 is retained by a retaining ring (not shown) mounted on a front end thereof. The gears 35 and 38 constitute a third reduction mechanism 41 (see FIGS. 3 and 5).

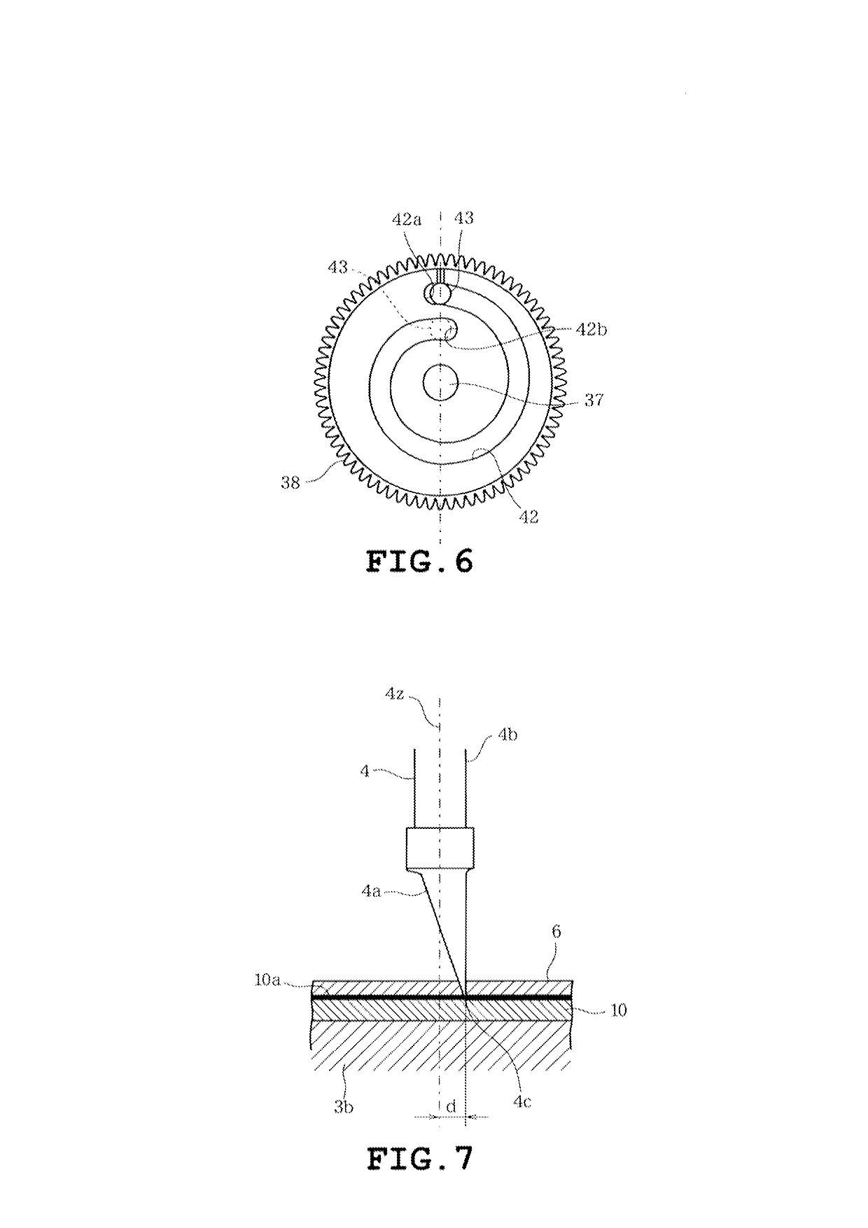

The gear 38 is formed with a spiral groove 42 as shown in FIG. 6. The spiral groove 42 is a cam groove formed into a spiral shape such that the spiral groove 42 comes closer to the center of the gear 38 as it is turned rightward from a first end 42a toward a second end 42b. An engagement pin 43 which is vertically moved together with the cutter holder 5 engages the spiral groove 42 as will be described in detail later (see FIG. 4). Upon normal or reverse rotation of the Z-axis motor 34, the gear 38 is rotated via the gear 35. Rotation of the gear 38 vertically slides the engagement pin 43 in engagement with the spiral groove 42. With the vertical slide of the gear 38, the cotter holder 5 is moved upward or downward together with the support shafts 33a and 33b. In this case, the cutter holder 5 is moved between a raised position (see FIGS. 4 and 6) where the engagement pin 43 is located at the first end 42a of the spiral groove 42 and a lowered position (see FIGS. 5 and 6) where the engagement pin 43 is located at the second end 42b. A third moving unit 44 which moves the cutter holder 5 upward and downward is constituted by the above-described third reduction mechanism 41 having the spiral groove 42, the Z-axis motor 34, the engagement pin 43, the support portions 32a and 32b, the support shafts 33a and 33b, etc.

The cutter holder 5 includes a holder body 45 provided on the support shafts 33a and 33b, a movable cylindrical portion 46 which has a cutter 4 (a cutting blade) and is held by the holder body 45 so as to be vertically movable and a pressing device 47 which presses the object 6. More specifically, the holder body 45 has an upper end 45a and a lower end 45b both of which are folded rearward such that the holder body 45 is generally formed into a C-shape, as shown in FIGS. 3 to 5, etc. The upper and lower ends 45a and 45b are immovably fixed to the support shafts 33a and 33b by retaining rings 48 fixed to upper and lower ends of the support shafts 33a and 33b, respectively. The support shaft 33b has a middle part to which is secured a coupling member 49 provided with a rearwardly directed engagement pin 43 as shown in FIGS. 4 and 5. The holder body 45, the support shafts 33a and 33b, the engagement pin 43 and the coupling member 49 are formed integrally with one another. The cutter holder 5 is vertically moved by the third moving unit 44 in conjunction with the engagement pin 43. Furthermore, two compression coil springs 50 serving as biasing members are mounted about the support shafts 33a and 33b so as to be located between an upper surface of the support portion 32a and an upper end 45a of the holder body 45, respectively. The entire cutter holder 5 is elastically biased upward by a biasing force of the compression coil springs 50 relative to the carriage 19.

Mounting members 51 and 52 provided for mounting the movable cylindrical portion 46, the pressing device 47 and the like are fixed to the middle portion of the holder body 45 by screws 54a and 54b respectively, as shown in FIG. 3. The lower mounting member 52 is provided with a cylindrical portion 52a (see FIG. 4) which supports the movable cylindrical portion 46 so that the movable cylindrical portion 46 is vertically movable. The movable cylindrical portion 46 has a diameter that is set so that the movable cylindrical portion 46 is brought into a sliding contact with the inner peripheral surface of the cylindrical portion 52a. The movable cylindrical portion 46 has an upper end formed with a flange 46a which projects radially outward to be supported on an upper end of the cylindrical portion 52a. A spring shoe 46b is provided on an upper end of the flange 46a. A compression coil spring 53 is interposed between the upper mounting member 51 and the spring shoe 46b of the movable cylindrical portion 46 as shown in FIG. 4. The compression coil spring 53 biases the movable cylindrical portion 46 (the cutter 4) to the lower object 6 side while allowing the upward movement of the movable cylindrical portion 46 against the biasing force when an upward force acts on the cutter 4.

The cutter 4 extends through the movable cylindrical portion 46. The cutter 4 includes a cutter shaft 4b and a blade 4a both formed integrally with the cutter 4 and extends in an axial direction of movable cylindrical portion 46. The cutter shaft 4b is formed into the shape of a long round bar and is longer than the movable cylindrical portion 46. The cutter shaft 4b has a lower end on which the blade 4a is formed. The blade 4a is formed into a substantially triangular shape and has a lowermost end serving as a blade edge 4c which is formed so as to assume a position shifted by a distance d from a central axis 4z of the cutter shaft 4b, as shown in FIG. 7. The movable cylindrical portion 46 has two bearings 55 (see FIG. 4) mounted on inner upper and lower ends thereof respectively. The cutter shaft 4b is mounted on the bearings 55 so as to be rotatable about the vertical central axis 4z, that is, a Z-axis. The cutter 4 presses the blade edge 4c against the X-Y plane or the surface of the object 6 from the Z direction perpendicular to the X-Y plane. Furthermore, the cutter 4 has a height that is set so that when the cutter holder 5 has been moved to the lowered position, the blade edge 4c passes through the object 6 on the holding sheet 10 but does not reach the upper surface of the plate member 3b of the platen 3, as shown in FIG. 7. On the other hand, the blade edge 4c of the cutter 4 is moved upward with movement of the cutter holder 5 to the raised position, thereby being spaced from the object 6 (see FIG. 4).

The mounting member 52 has three guide holes 52b, 52c and 52d (see FIGS. 2 to 5) which are formed at regular intervals in a circumferential edge of the lower end of the cylindrical portion 52a. A pressing member 56 is disposed under the cylindrical portion 52a. and has three guide bars 56b, 56c and 56d which are to be inserted into the guide holes 52b to 52d respectively. The pressing member 56 includes a lower part serving as a shallow bowl-shaped pressing portion body 56a. The aforementioned equally-spaced guide bars 56b to 56d are formed integrally on the circumferential end of the top of the pressing portion body 56a. The guide bars 56b to 56d are guided by the respective guide holes 52b to 52d, so that the pressing member 56 is vertically movable. The pressing portion body 56a has a central part formed with a through hole 56e which vertically extends to cause the blade 4a to protrude downward therethrough. The pressing portion body 56a has an underside serving as a contact surface 56f which is brought into contact with the object 6 around the blade 4a. The contact portion 56f is formed into an annular horizontal flat surface and is brought into surface contact with the object 6. The contact portion 56f is made of a fluorine resin such as Teflon® so as to have a lower coefficient of friction, whereupon the contact portion 56f is rendered slippery relative to the object 6.

The pressing portion body 56a has a connection 56g which is formed integrally on the circumferential edge thereof so as to extend forward, as shown in FIGS. 3 to 5 etc. On the other hand, the mounting member 52 has a front mounting portion 52e for the solenoid 57, integrally formed therewith. The front mounting portion 52e is located in front of the cylindrical portion 52a and above the connection 56g. The solenoid 57 serves as an actuator for vertically moving the pressing member 56 thereby to press the object 6. The solenoid 57 and the pressing member 56 constitute a pressing device 47 together with a control circuit 61 which will be described later. The solenoid 57 is mounted on the front mounting portion 52e so as to be directed downward. The solenoid 57 includes a plunger 57a having a distal end fixed to an upper surface of the connection 56g. The solenoid 57 is driven with the cutter holder 5 assuming the lowered position as will be described in more detail later. In this case, the pressing member 56 is moved downward together with the plunger 57a thereby to press the object 6 with a predetermined pressure (see FIG. 5). On the other hand, when the plunger 57a is located above during non-drive of the solenoid 57, the pressing member 56 releases the object 6 from application of the pressing force. When the cutter holder 5 is moved to the raised position during non-drive of the solenoid 57 (see two-dot chain line in FIG. 4), the pressing member 56 is completely spaced from the object 6. A cutting unit 58 (see FIG. 1) is constituted by the above-described cutter 4, the first to third moving units 7, 8 and 44, the control circuit 61, the pressing device 47 and the like.

The holding sheet 10 serving as a holding member is made of, for example, a synthetic resin and formed into a flat rectangular plate shape, as shown in FIG. 1. The adhesive layer 10a (see FIG. 7) is formed by applying an adhesive agent to an upper side of the holding sheet 10, that is, a side thereof opposed to the cutter 4. The adhesive layer 10a is formed in an area of the holding sheet 10 located inside the outer edge of the holding sheet 10 by a predetermined distance and has a rectangular shape as viewed in a plane. The holding sheet 10 has a peripheral edge including a right and left edges 102 and 101 and front and rear edges 104 and 103 in each of which no adhesive layer 10a is provided. The right and left edges 102 and 101 serve as supported portions which are vertically held by the pressing portions 12a to 13b of the drive roller 12 and the pinch roller 13 thereby to be supported. FIG. 1 shows the adhesive layer 10a including a lower part covered with two objects 6A and 6B.

The sheet-like object 6 such as paper, cloth or resin film is removably held by the adhesive layer 10a. The adhesive layer 10a has an adhesion that is set to a small value such that the object 6 can easily be removed from the adhesive layer 10a without breakage of the object 6. Thus, when cut by the cutting apparatus 1, the object 6 is held by the adhesion of the adhesive layer 10a and the pressing force of the pressing device 47 so as to be immovable relative to the holding sheet 10.

Point O in FIG. 1 designates a left rear corner of the holding sheet 10. The cutting apparatus 1 includes a detection sensor 66 (see FIG. 8) which detects the holding sheet 10 set via the opening 2a. The control circuit 61 sets as an origin (X0, Y0) the point O of the set holding sheet 10, based on a detection signal supplied from the detection sensor 66. Thus, the cutting apparatus 1 has a coordinate system with the origin O of the holding sheet 10 serving as a reference point and performs relative movement of the cutter 4 and the object 6 on an X-Y coordinate system by the first and second moving units 7 and 8 based on cutting line data which will be described later. In the coordinate system of the cutting apparatus 1, a direction from the left toward the right of the holding sheet 10 is referred to as a positive direction of the X axis, and a direction from the rear toward the front of the holding sheet 10 (that is, a direction in which the holding sheet 10 is moved rearward) is referred to as a positive direction of the Y axis.

The cutting apparatus 1 of the embodiment is provided with an imaging member 59 which detects information including a holding position of the object 6 on the holding sheet 10. The imaging member 59 would be a contact image sensor (CIS) mounted on a rear end of the cutting apparatus 1, for example, as shown in FIG. 2. The imaging member 59 is configured to be capable of imaging an upper surface of the object 6 in proximity to the upper side of the holding sheet 10 placed on the platen 3.

The imaging member 59 includes a line sensor further including a plurality of imaging devices lined in the X direction, a light source and a lens all of which are formed integrally with one another although not shown in detail. The imaging member 59 extends in the X direction between the right and left edges 101 and 102 of the holding sheet 10 and is disposed so as to image the object 6 on the holding sheet 10 moved by the first moving unit 7 toward the rear of the platen 3b in the Y direction.

The control circuit 61 executes an imaging process at a constant imaging interval by the imaging member 59 when the object 6 passes the underside of the imaging member 59 with the movement of the holding sheet 10 in the Y direction. In this case, the object 6 is imaged at an imaging interval according to a moving speed of the holding sheet 10 so that an imaging range of the object 6 is continuous. As a result, an image of an entire region of the object 6 on the holding sheet 10 is generated.

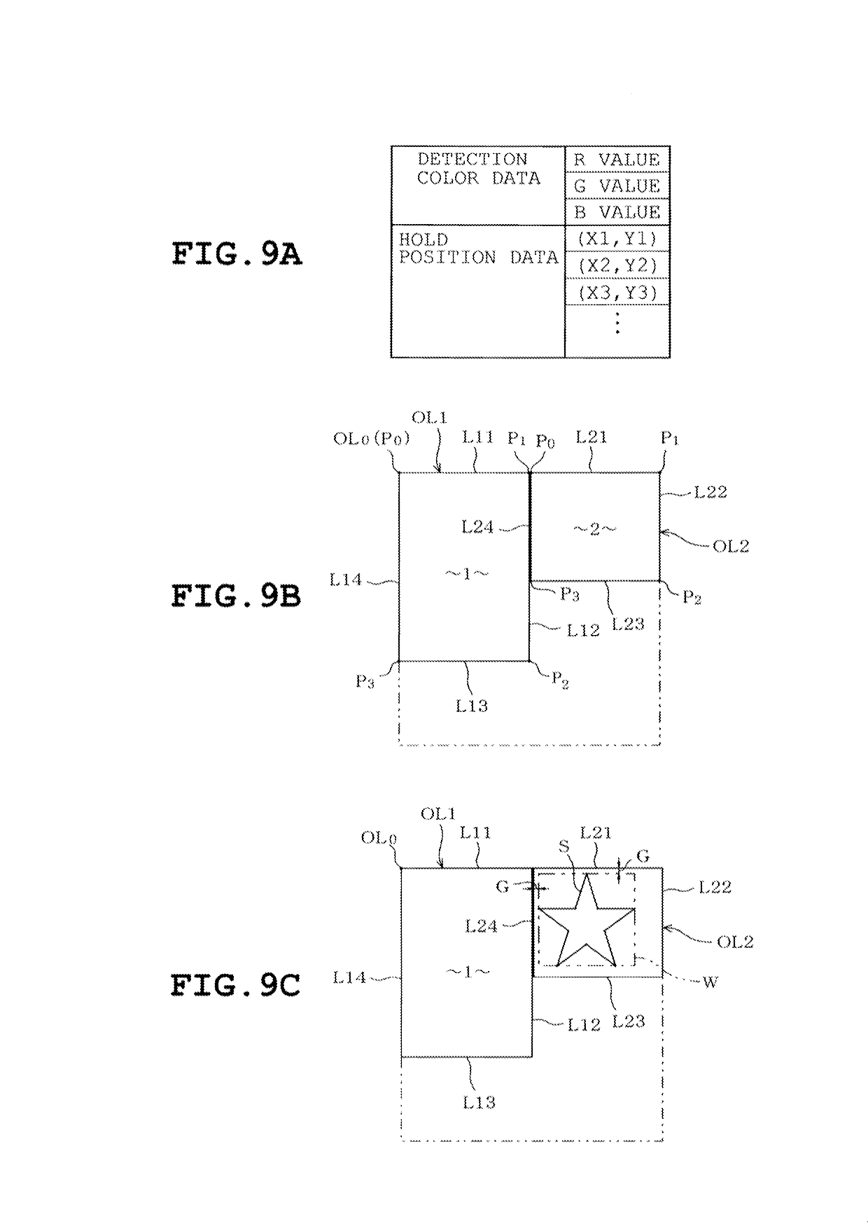

Furthermore, the control circuit 61 extracts a color and an outline or contour of the object 6 from data of the image of the object 6. For example, data of outlines OL1 and OL2 as shown in FIG. 9B is generated from the image data in the case of images of the aforementioned objects 6A and 6B (see FIG. 1). In this case, data of coordinate values of points P₀, P₁, P₂ and P₃ is extracted regarding line segments L11 to L14 composing an outline OL1 of the object 6A. Also, data of coordinate values of points P₀, P₁, P₂ and P₃ is extracted regarding line segments L21 to L24 composing an outline OL2 of the object 6B. The extracted coordinate values (hereinafter referred to as “coordinate values of outline OL”) are defined by a coordinate system of the cutting apparatus 1 with the origin O of the holding sheet 10 serving as a reference point. More specifically, coordinate values of the outline OL are indicative of hold positions of the objects 6A and 68 when point OL₀ corresponding to the origin O of the holding sheet 10 is a coordinate origin.

Known techniques are available for image processing including a process of generating an outline OL on the basis of image data. Accordingly, a detailed description of the image processing will be eliminated.

The above-described control circuit 61 and the imaging member 59 constitute a detection unit which detects information inclusive of the hold position, and the color, outline OL and the like of the object 6 (6A, 6B).

An arrangement of the control system of the cutting apparatus 1 will be described with reference to a block diagram of FIG. 8. The control circuit (a control unit) 61 controlling the entire cutting apparatus 1 is mainly composed of a computer (CPU). To the control circuit 61 are connected a ROM 62, a RAM 63 and an external memory 64. The ROM 62 stores a cutting control program for control of a cutting operation, a display control program for control of displaying by the display 9, an arrangement setting program which will be described later, and the like. The RAM 63 temporarily stores various data and program necessary for execution of each processing.

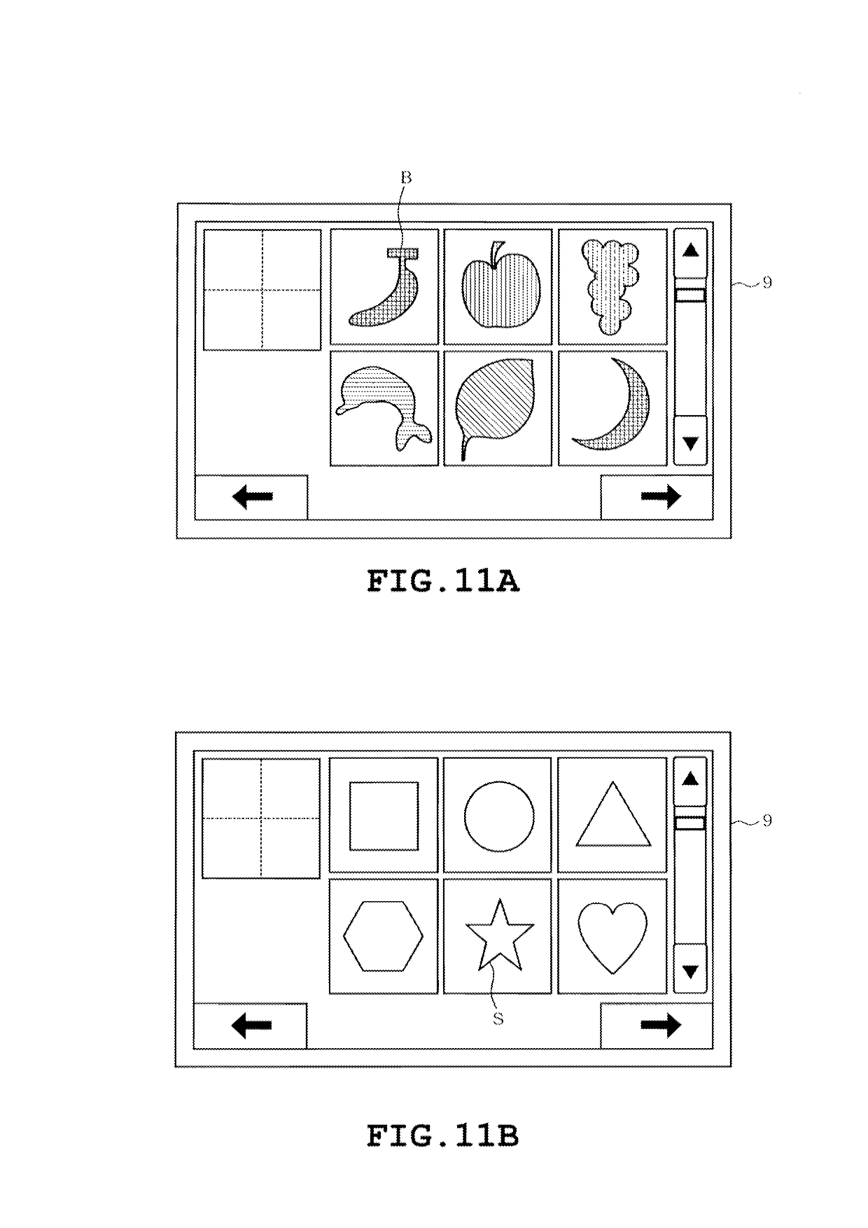

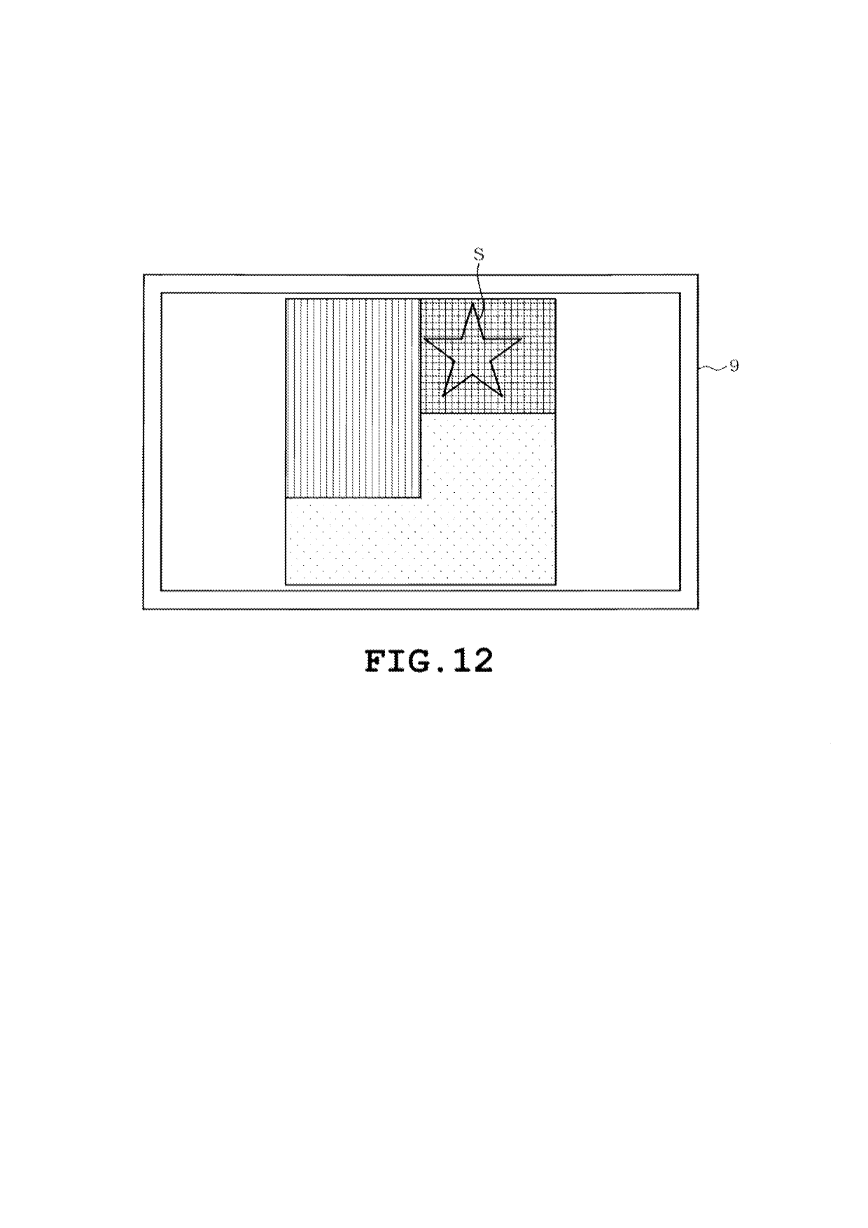

To the control circuit 61 are supplied operation signals generated by various operation switches 65 and detection signals generated by the detection sensor 66, the imaging member 59 and the like. The display 9 is electrically connected to the control circuit 61. A pattern selecting screen (see FIGS. 11A and 11B) which will be described later, an arrangement setting screen (see FIG. 12) and the like are displayed on a screen of the display 9. While viewing the contents displayed on the display 9, the user operates one or more of various operation switches 65 to select a desired pattern. The display 9 and the operation switches 65 constitute a pattern selecting unit. Furthermore, to the control circuit 61 are connected drive circuits 67 to 70 driving the Y-axis motor 15, the X-axis motor 26, the Z-axis motor 34 and the solenoid 57 respectively. The control circuit 61 executes the cutting control program to control the Y-axis motor 15, the X-axis motor 26, the Z-axis motor 34 and the solenoid 57, so that a cutting operation is automatically executed for the object 6 on the holding sheet 10.

The RAM 63 has a storage area for temporarily storing data of a color of the object 6 and data of the outline OL. FIG. 9A shows the structure of data of the object 6 stored in the RAM 63. Detected color data is indicative of, for example, RGB values of image data obtained by the imaging by the imaging member 59 and is data of a detected color within a region defined by the outline OL (that is, the object 6). Hold position data (X1, Y1), (X2, Y2), (X3, Y3) . . . is extracted from the image data and is indicative of a coordinate value of the outline OL in the case where point OL₀ corresponding to the origin O of the holding sheet is a coordinate origin. The hold position of the object 6 on the holding sheet 10 is specified from the hold position data. For example, in the case of the objects 6A and 6B as shown in FIG. 1, the control circuit 61 discriminates two rectangular regions as two objects 6A and 6B since points P0 to P3 of the outlines PL1 and OL2 can be connected to one another by straight lines, respectively. As a result, detected color data and hold position data are configured to be stored so as to be correlated with the objects 6A and 6B.

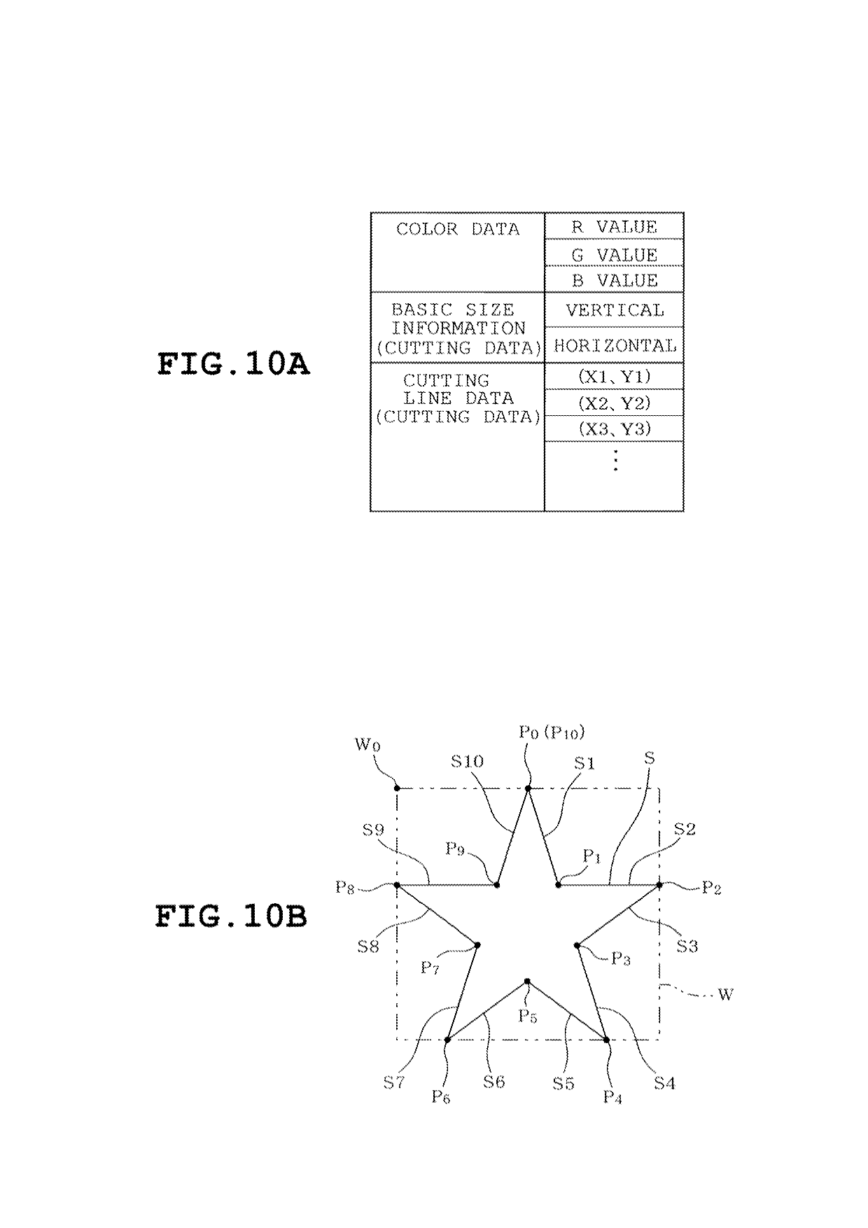

The external memory 64 stores, as a first storage unit, cutting data used to cut a pattern by the cutting apparatus 1 and the color data both correlated with each for every pattern. FIG. 10A shows a data structure of the cutting data and the color data. The color data shown in FIG. 10A uses RGB values and corresponds to type data specifying a type of the object 6. More specifically, color data are set for respective six patterns shown in FIG. 11A. For example, yellow is set for a banana and the moon, red for an apple, purple for grapes, blue for a dolphin, green for a leaf, and the like. On the other hand, a pattern can be cut out of the object 6 of any color. For example, color data is set for none of six patterns of a square, a triangle, a hexagonal shape, a star and a heart.

The cutting data includes basic size information and cutting line data both shown in FIG. 10A and data for display purpose. The basic size information represents values indicative of horizontal and vertical size and is shape data corresponding to a shape of the pattern. For example, shape data of pattern S of “star” as shown in FIG. 10B is represented as the size of a rectangular frame W encircling the pattern S in proximity to apexes P₀, P₂, P₄, P₆ and P₈. The cutting data including the shape data of each pattern is stored on the external memory serving as the second storage unit.

The cutting line data includes data of coordinate values indicative of apexes of a cutting line composed of a plurality of line components, in the form of XY coordinate, and is defined by the coordinate system of the cutting apparatus 1. More specifically, a cutting line of the pattern S is composed of line components S1 to S10 and formed into a closed star shape having a cutting start point P₀ and a cutting end point P₁₀ corresponding with each other, as shown in FIG. 10B. The cutting line data has a first coordinate value (X1, Y1), a second coordinate value (X2, Y2), a third coordinate value (X3, Y3) . . . and an eleventh coordinate data corresponding to a cutting start point P₀, an apex P1, apex P2, apex P3, . . . and a cutting end point P10 respectively. Cutting is executed on the basis of the cutting line data under the condition that a left upper point W₀ of the rectangular frame W in FIG. 10B serves as a coordinate origin, which corresponds to the origin O of the holding sheet 10.

More specifically, when the pattern S is cut by the cutting apparatus 1, the holding sheet 10 (the object 6) is moved in the Y direction by the first moving unit 7 and the cutter holder 5 is moved in the X direction by the second moving unit 8, so that the cutter 4 is relatively moved to the X-Y coordinate of the cutting start point P₀ of the pattern S. Next, the blade edge 4c of the cutter 4 is moved through the object 6 at the cutting start point P₀ by the third moving unit 44 and further relatively toward the coordinate of the end point P₁ of the line segment S1 by the first and second moving units 7 and 8. As the result of the relative movement of the cutter 4, the object 6 is cut along the line segment S1. Regarding the subsequent line segment S2, cutting is continuously executed in the same manner as of the line segment S1 with the end point P1 of the previous line segment S1 serving as a start point. Thus, cutting is sequentially executed also regarding the line segments S2 to S10, whereupon the cutting lines of the pattern S of “star” are cut based on the cutting line data.

Regarding the above-described cutting of the pattern, the control circuit 61 executes the arrangement setting program thereby to automatically set an arrangement position of the pattern according to the object 6 on the holding sheet 10. In this case, when color data is set for the pattern to be cut, the control circuit 61 determines an arrangement of the pattern according to the object 6 in the same color as the color data or an approximate color as will be described in more detail later. On the other hand, when no color data is set for the pattern to be cut, the control circuit 61 determines an arrangement of the pattern irrespective of a color of the pattern. Consequently, the cutting apparatus 1 is configured to cut an automatically arranged pattern out of the object 6 with the predetermined or any color.

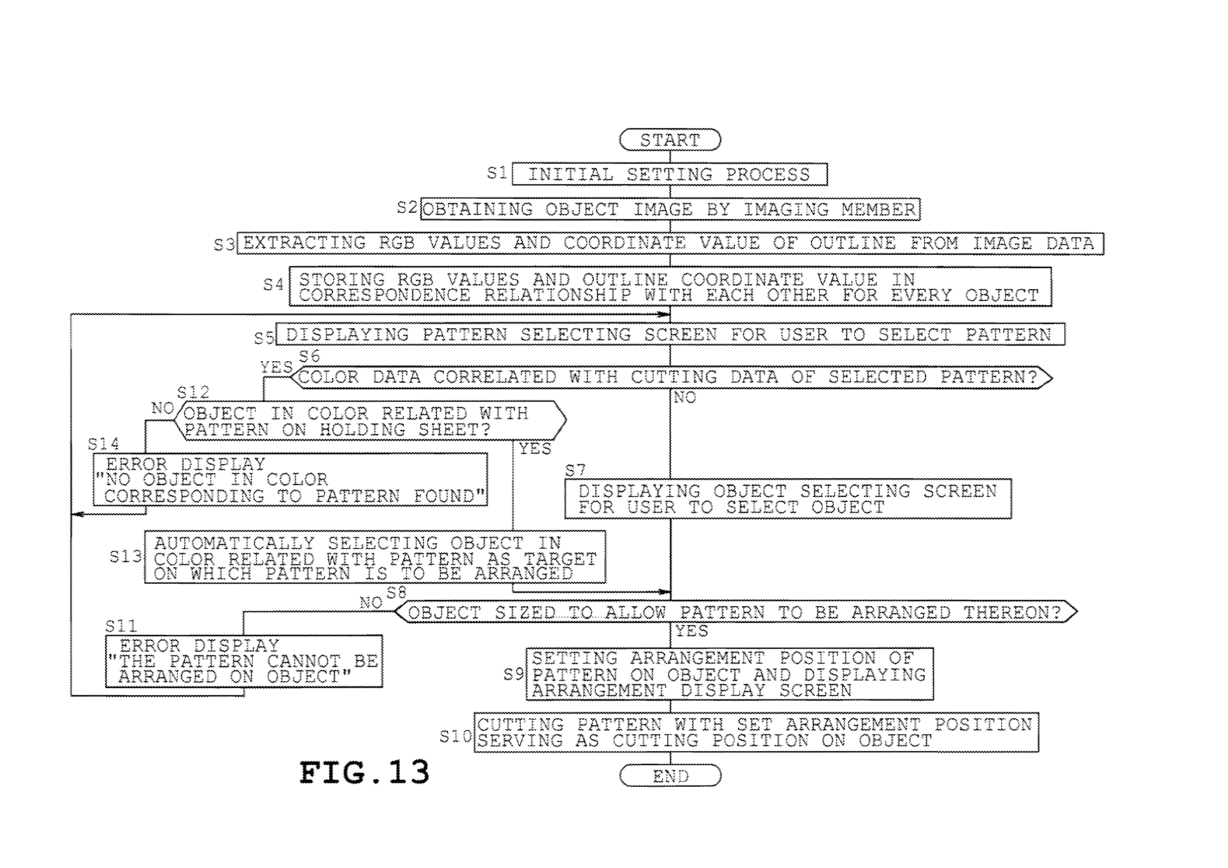

The working of the cutting apparatus constructed as described above will now be described with reference to FIGS. 11A to 13 as well as FIGS. 1 to 10. FIG. 13 is a flowchart showing the processing of an arrangement setting program to be executed by the control circuit 61. A case where two objects 6A and 6B as shown in FIG. 1 are affixed to the holding sheet 10 will be exemplified in the following description, for example. The object 6A is a piece of red paper and the object 6B is a piece of yellow paper. Furthermore, the objects 6A and 6B are adapted to be held on the holding sheet 10 so as to both cover the rear of the adhesive layer 10a and so as not to overlap each other.

The user sets the holding sheet 10 holding the objects 6A and 6B through the opening 2a into the cutting apparatus 1 and then operates one or more of the operation switches 65 to instruct “paper feed.” As a result, the control circuit 61 actuates the first moving unit 7 to feed the holding sheet 10 rearward and sets an origin O of the holding sheet 10 based on a detection signal regarding the holding sheet 10 by the detection sensor 66, thereby executing an initial setting process (step S1). Subsequently, the control circuit 61 moves the holding sheet 10 rearward to the imaging member 59 side and executes an imaging process when the objects 6A and 6B pass through the underside of the imaging member 59 (step S2). In the imaging process, the objects 6A and 6B are imaged by the imaging member 59 at an imaging interval according to a moving speed of the holding sheet 10 so that imaging ranges of the objects 6A and 6B are continuous, thereby generating images of upper sides of the objects 6A and 6B.

The control circuit 61 further identifies the two objects 6A and 6B and extracts RGB values as detection color data and coordinate values of outlines OL1 and OL2 serving as hold position data from data of generated images (step S3). In this case, object number 1 is assigned to the identified object 6A, and detection color data of red is stored on the RAM 63 in correspondence relationship with the hold position data of the outline OL1 (see FIG. 9B). In the same manner, object number 2 is assigned to the identified object 6B, and detection color data of yellow and the hold position data of the outline OL2 are correlated with each other to be stored on the RAM 63 (step S4).

A pattern selecting screen for selection of a pattern is displayed on the display 9. Patterns are divided into a first group of patterns (see FIG. 11A) each of which has color data related therewith and a second group of patterns (see FIG. 11B) each of which has no color data set. The user then operates one or more of the operation switches 65 to select a desired pattern of either group (step S5). As a result, cutting data of the selected pattern is loaded from the external memory 64. In this case, the control circuit 61 determines whether or not color data is related with the selected cutting data, that is, whether or not the pattern has been given color data set as shown in FIG. 11A (step S6).

When the pattern selected by the user is a pattern S of “star”as shown in FIG. 11B, no color data is related with the pattern S (NO at step S6). In this case, the control circuit 61 proceeds to step S7 to display an object selecting screen (not shown) on the display 9. Images of the objects 6A and 6B (or the outlines OL1 and OL2) are displayed with a suitable scale on the object selecting screen, for example, based on image data generated at step S2. In this regard, object Nos. 1 and 2 may also be displayed within the outlines OL1 and OL2 respectively as shown in FIG. 9B. While viewing the object selecting screen, the user operates one or more of the operation switches 65 to select either object No. 1 or 2. The step S7 may be eliminated when a single object 6 is held on the holding sheet 10.

For example, when the object 6B of object No. 2 has been selected at step S7, the control circuit 61 determines whether or not the object 6B is sized to allow the pattern S to be arranged thereon, based on hold position data of the outline OL2 of the object 6B and shape data of the rectangular frame W of the pattern S (step S8). When the object 6B is sized to allow the pattern S to be arranged thereon (YES at step S8), the control circuit 61 changes the coordinate value of the cutting data (cutting line data) on the basis of the hold position data of the object 6B so that the pattern S is located in an area inside the outline OL2 (step S9).

In the above-described case, the control circuit 61 sets the pattern S at an arrangement position that is located 5 mm inside the outline OL2 and shifted toward a left rear corner, for example. More specifically, the arrangement position of the pattern S is changed so as to have such a coordinate value that a blank space G of 5 mm is defined between the line segment L24 of the outline OL2 and the left side of the rectangular frame W and between the line segment L21 and the rear side of the rectangular frame W. As a result, the pattern S is adapted to be automatically set at an arrangement position where the cutting line thereof is reliably within an area of the object 6B and which improves the yield. The coordinate value of the arrangement position of the pattern S set by the automatic arrangement is stored on the RAM 63 as cutting data of the pattern S.

Furthermore, the control circuit 61 proceeds to step S9 to generate data of a composite image in which the pattern S is superimposed on the image of object 6A or 6B at the set arrangement position, based on the image data generated at step S2 and post-conversion cutting data. The control circuit 61 then displays an arrangement display screen on the display 9 to display the pattern S located at the set arrangement position on the screen, as shown in FIG. 12. The objects 6A and 6B and the pattern S are displayed with a suitable reduced scale on the arrangement display screen, so that the user can view the arrangement position of the pattern S.

The user then operates one or more of the operation switches 65 to instruct start of cutting. In this case, the pattern S is cut out of the object 6B by the cutting unit 58 on the basis of the cutting data with the arrangement position of the pattern S serving as a cutting position on the object 6B, that is, on the supposition that the coordinate origin OL₀ of the post-conversion cutting data corresponds to the cutting position of the object 6B (step S10). Thus, the pattern S of “star” is completely cut out of the yellow object 6B (END).

When the control circuit 61 determines at step S8 that the object 6 is not sized so as to allow the pattern to be arranged thereon (NO), the display 9 displays, as a result of determination, a message that the pattern cannot be arranged on the object 6 (step S11). In this case, the control circuit 61 returns to step S5, so that the user can reselect a pattern.

When a pattern selected by the user is correlated with color data, differing from the above-described case of the pattern S (YES at step S6), the control circuit 61 checks detection color data of the objects 6A and 6B regarding color data of the selected pattern to determine whether or not an object in a color correlated with the pattern is on the holding sheet 10 (step S12). For example, color data of “yellow” is set on the pattern B of “banana” as shown in FIG. 11A. Accordingly, when detection color data of the object 6B corresponds to color data of the pattern B or has approximate RGB values to those of the color data of the pattern B, the object 6B is determined to have a color correlated with the pattern B (YES at step S12).

Furthermore, the control circuit 61 sets the object 6B as a target on which the pattern B is to be placed, based on the result of determination at step S12 (step S13). When a plurality of objects in respective colors correlated with the pattern B is placed on the holding sheet 10, the control circuit 61 selects one of the objects (a larger object, for example). Subsequently, the control circuit 61 proceeds to step S8 to determine whether or not the object 6B is sized so as to allow the pattern B to be arranged thereon, based on the hold position data of the outline OL2 of the object 6B and the shape data of a rectangular frame (not shown) of the pattern B of “banana.” When determining that the pattern B can be arranged on the object 6B (YES at step S8), an arrangement position of the pattern B on the object 6B is automatically set. A pattern B arrangement display screen is displayed or the display 9 (step S9). Thereafter, the pattern B of “banana” is cut out of the object 6B of a predetermined color by the cutting unit 58 with the arrangement position serving as a cutting position in the object 6B (step S10).

When determining at step S12 that there is no object that has detection color data which corresponds or approximates to the color of the pattern on the holding sheet 10 (NO), the control circuit 61 actuates the display 9 to display a message that there is no object 6 in color related to the pattern, as the result of determination (step S14). In this case, the control circuit 61 returns to step S5, so that the user can reselect a pattern.

When cutting is carried out by the above-described cutting apparatus 1, the solenoid 57 can be driven to press the contact portion 56f against the object 6, and the object 6 can be held by an adhesive force of the adhesive layer 10a of the holding sheet 10 so as not to stir. The pressing member 56 is moved relative to the object 6 in this case. However, since the contact portion 56f of the pressing member 56 is formed of a material with low friction coefficients, a fractional force caused between the contact portion 56f and the object 6 can be reduced as much as possible. Accordingly, the object 6 can be prevented from movement due to the frictional force, whereupon the object 6 can be held more reliably and cut more accurately.

The control circuit 61 in relation with execution of steps S8 and S9 serves as an arrangement unit which sets an arrangement position on the object 6 of the pattern selected by the pattern selecting unit, based on the hold position of the object 6 detected by the detection unit.

The control circuit 61 of the foregoing embodiment executes a detection routine (steps S2 to S4) of detecting information inclusive of the hold position of the object 6 held on the holding sheet 10 and an arrangement routine (steps S8 and S9) of setting an arrangement position on the object 6 of the pattern selected by the pattern selecting unit, based on the hold position of the object 6 detected in the detection routine. According to this, the arrangement position of the pattern on the object 6 is set in the arrangement routine based on the hold position of the object 6 detected in the detection routine. Accordingly, even when the object 6 is affixed to any position on the holding sheet 10, the pattern is automatically arranged so as to correspond to the hold position of the object 6, with the result that the pattern can be cut more easily. Additionally, a failure that a pattern to be cut runs over the object 6 can be prevented.

The control circuit 61 executes a display routine (step S9) of displaying a pattern so that the pattern corresponds to the arrangement position, when the arrangement position of the pattern has been set in the arrangement routine. According to this, the user can view the pattern selected by the pattern selecting unit together with the arrangement position thereof. Furthermore, the user can confirm that the arrangement position of the pattern corresponds to a desired cutting position according to the hold position of the object 6.

When the user affixes a plurality of types of objects 6 to arbitrary positions on the holding sheet 10, the control circuit 61 determines as a type determination unit whether or not the objects 6 includes one related with the selected pattern (see step S6 and a type determination routine at step S12). When the selected pattern and the object 6 related with the selected pattern are present, the arrangement position of the pattern on the corresponding object 6 is automatically set. As a result, the selected pattern can be cut out of the predetermined type of the object 6 without the user setting an arrangement position of the pattern on the object 6. Furthermore, based on the type data of the pattern and the detection data of the object 6, the control circuit 61 determines whether or not a type of object 6 related with the pattern is on the holding sheet 10. This can prevent the cutting based on a wrong type of object 6 can be prevented.

The type data includes at least the color data specifying the color of the object 6. Furthermore, the detection data includes at least the detection color data specifying the color of the object 6. Consequently, the arrangement position of the selected pattern can automatically be set on the object 6 of a predetermined color, whereupon the object of an incorrect color can be prevented from being cut.

By the use of the imaging member 59, types of designs, materials and the like of the object 6 can be obtained from the image data as detection data as well as the color of the object 6. The type data may then include design data (for example, polka-dot, stripe, waffle pattern and the like) specifying design of the object 6 or material data (for example, coat paper, art paper, matte paper and the like in the case of paper; and felt, denim, broadcloth and the like in the case of cloth) as well as the color data. More specifically, the control circuit 61 may be configured to set an arrangement position of a type of object 6 related with any one of types of color data, design data and material data, based on detection data of color, design, material and the like of the object 6. As a result, a desired pattern and the object 6 with design suitable for the pattern can be cut in correlation with each other, for example. Furthermore, since the objects 6 differ in thickness, stretchability or the like depending upon the material, a pattern with a complicated shape and an object 6 with a low stretchability may be correlated with each other, whereupon a suitable cutting manner can be carried out according to a material of the object 6.

The control circuit 61 and the display 9 constitute a first informing unit and execute a first informing routine of informing of the result of determination by the type determination unit at steps S14 and S9. According to this, when the object 6 differs from a predetermined type, the user resets the objects based on the contents informed by the first informing unit, thereby reliably preventing the cutting of a wrong type of object 6.

The control circuit 61 serves as a size determination unit and executes, at step S8, a size determination routine of determining whether or not the object 6 on the holding sheet 10 has a size corresponding to the pattern.

When the user has affixed to the holding sheet 10 a plurality of objects 6 having different sizes at respective any positions, the control circuit 61 determines, in the size determination routine, whether or not the objects 6 include one corresponding to the shape of the selected pattern. When the objects 6 include one corresponding to the shape of the selected pattern, the control circuit 61 proceeds to the arrangement routine to automatically set an arrangement position of the pattern on the corresponding object 6. As a result, the selected pattern can be cut out of the object 6 inside which the selected pattern fits without the user setting an arrangement position of the pattern on the object 6 in the cutting apparatus 1. Accordingly, the entire pattern can be cut out of the object 6 having a size corresponding to the selected pattern, whereupon the pattern can be prevented from being cut out of the object 6 with a wrong hold position or a wrong size.

The control circuit 61 and the display 9 constitute a second informing unit and execute a second informing routine of informing of the result of determination in the size determination routine at steps S9 and S11. According to this, the user can reliably recognize size suitability of the object 6 set on the holding sheet 10. This can reliably prevent the cutting of a wrong type of object 6.

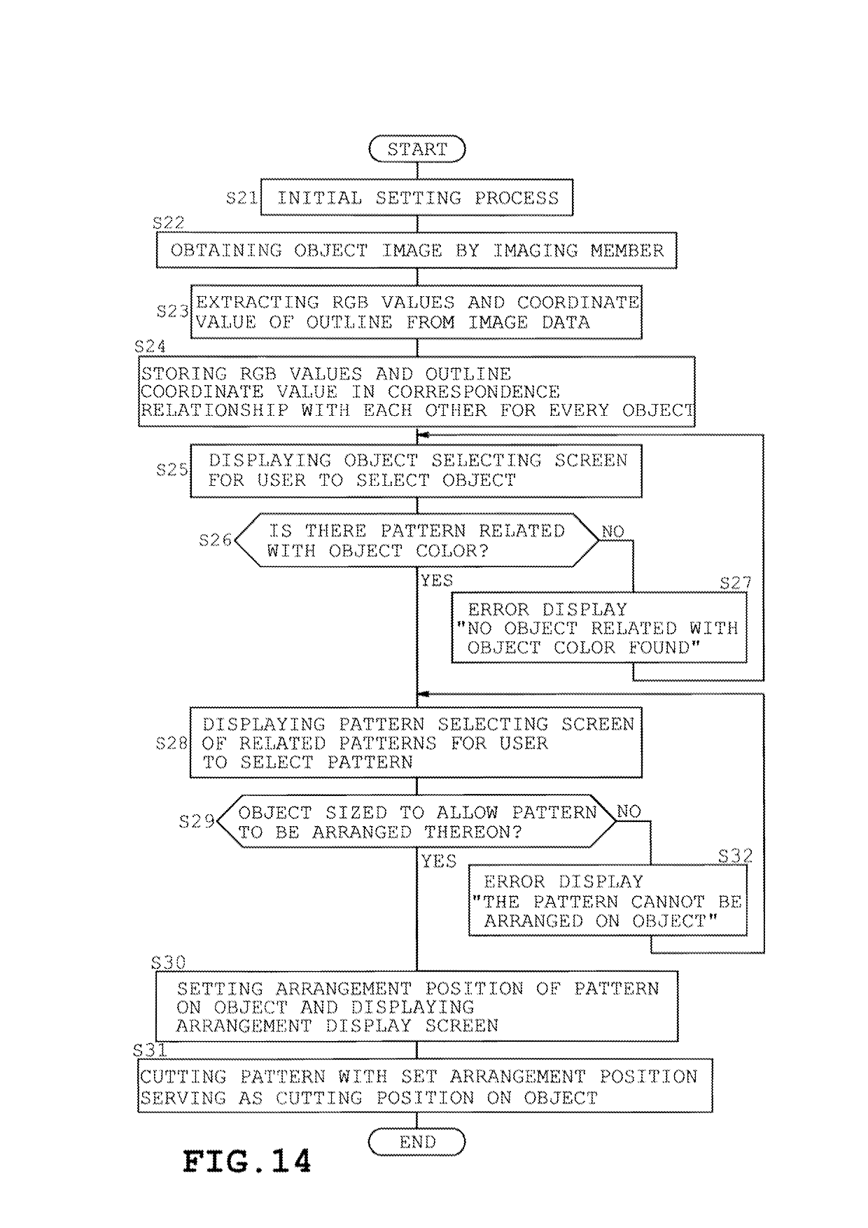

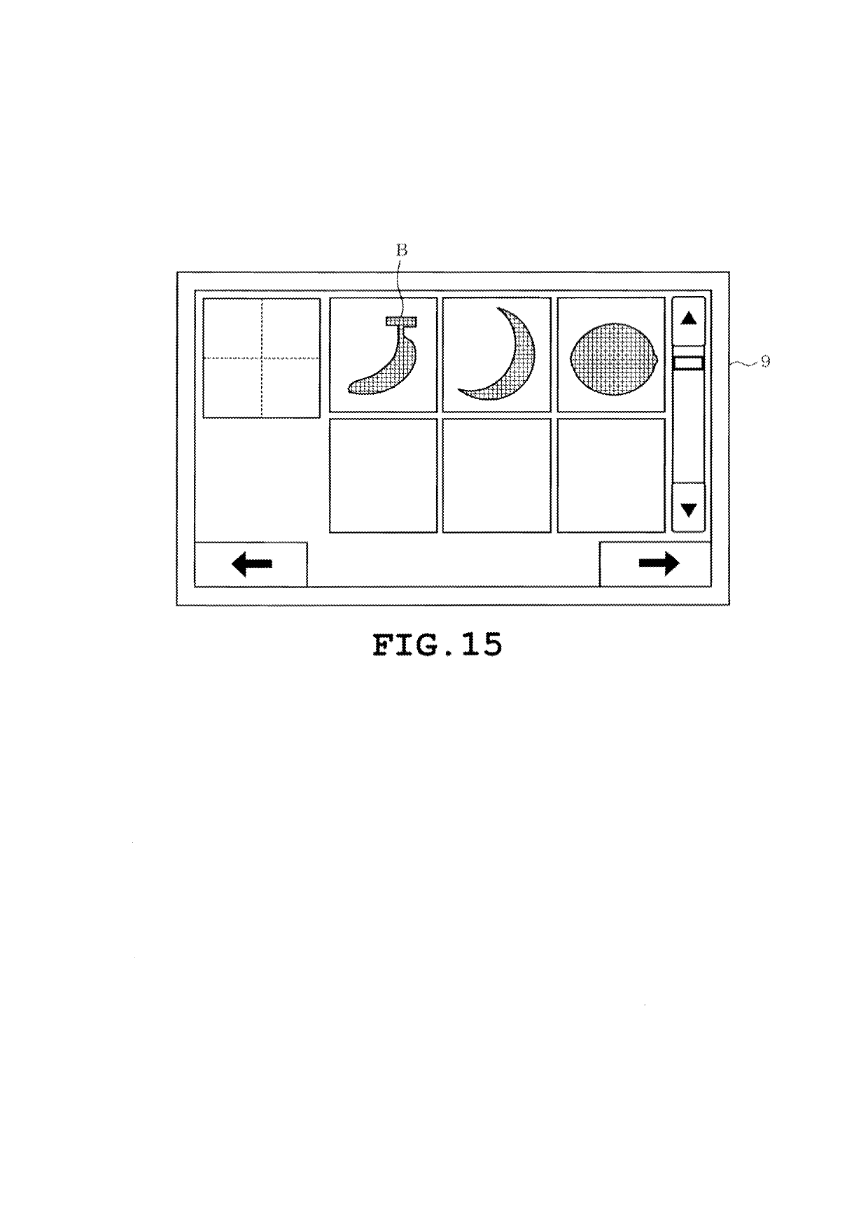

FIGS 14 and 15 illustrate a second embodiment. Only the differences between the first and second embodiments will be described. Identical or similar parts are labeled in the second embodiment by the same reference symbols as those in the first embodiment.

The same processes as the steps S1 to S4 in the first embodiment are carried out in the second embodiment as shown in the flowchart of FIG. 14. More specifically, after the origin O of the set holding sheet 10 has been set, an imaging process (steps S21 and S22) is executed in the cutting apparatus 1 to generate images of the upper surfaces of the objects 6 on the holding sheet 10. Furthermore, detection color data and hold position data of the objects 6A and 6b are extracted to be stored on the RAM 63 (steps S23 ad S24).

Either or any one of the plural objects 6A and 6B is selected before selection of a pattern in the second embodiment. More specifically, the object selecting screen is displayed on the display 9 at step S25. The user operates one or more of the operation switches 65 to select desired object Nos. 1 and 2. In this case, when the object 6 of object No. 2 is selected, for example, the control circuit 61 checks color data of a plurality of patterns stored in the external memory 64 (data indicated by RGB values, for example) to determine whether or not there is a pattern whose color data corresponds or approximates to detection color data (RGB values of “yellow”) of the object 6B (step S26).

When there is no pattern whose color data corresponds or approximates to detection color data of the object 6B (NO at step S26), the control circuit 61 displays, as the result of determination, that there is no pattern related with the color of the object 6 (step S27). In this case, the control circuit 61 returns to step S25 in order that the user may reselect the object 6A or 6B.

On the other hand, when there is a pattern whose color data corresponds or approximates to detection color data of the object 6B (YES at step S26), a pattern selecting screen as shown in FIG. 15 is displayed on the display 9. In this case, the control circuit 61 sorts out all the patterns (patterns of “banana,” “moon” and “lemon”) that correspond or approximate to the detection color data of the object 6, from a plurality of patterns stored on the external memory 64, displaying the sorted patterns on the pattern selecting screen. The user then operates one or more of the operation switches 65 to select the pattern B of “banana,” for example (step S28).

The control circuit 61 successively determines whether or not the object 6B has a size allowing the pattern B to be arranged thereon, based on the hold position data of the object 6 and shape data of a rectangular frame (not shown) of the selected pattern B (step S29). When the object 6B has a size allowing the pattern B to be arranged thereon (YES at step S29), the control circuit 61 converts the coordinate value of the cutting data so that the pattern B fits inside the object 6B, based on the hold position data of the outline OL2. Furthermore, post-conversion cutting data is stored on the RAM 63 and an arrangement display screen displaying the pattern S at the arrangement position is displayed on the display 9 in the same manner as in the first embodiment (step S30).

Subsequently, upon instruction of cutting start, the pattern B is cut by the cutting unit 58 with the aforesaid arrangement position serving as a cutting position in the object 6B (step S31). Thus, the pattern B of the color related with the object 6B of “yellow” can be cut out of the desired object 6 (END).

When determining at step S29 that the object 6B does not have a size allowing the pattern B to be arranged thereon (NO), the control circuit 61 displays, as the result of determination, that the pattern cannot be arranged on the object 6 (step S32). In this case, the control circuit 61 returns to step S28 so that the user can re-execute pattern selection.

The control circuit 61 and the operation switches 65 serve as the object selecting unit which selects a desired object from the plural objects 6. Furthermore, the control circuit 61 related with execution of steps S26 and S23 serves as the pattern selecting unit which selects a pattern related with the type (color) of the selected object, based on the detection data (detection color data) of type of the object 6 selected by the object selection unit and type data (color data) of a plurality of patterns stored on the first storage unit.

The control circuit 61 sets an arrangement position on the selected object 6 of the pattern selected by the pattern selecting unit (steps S29 and S30). According to this, the pattern can be cut out of the selected object 6 without the user setting the arrangement position of the pattern on the object 6 in the cutting apparatus 1. The pattern selecting unit further selects a pattern related with the type of the selected object based on the type data of the pattern and detection data of the object. As a result, the pattern can be cut out of the predetermined type of object.

The control circuit 61 and the display 9 both related with execution of the step S27 serve as a third informing unit which informs of the result of selection by the pattern selecting unit. According to this, when there is no pattern related with the selected object 6, the user can re-select an object 6 based on the contents informed of by the third informing unit or take another measure, whereupon a wrong type of object 6 can reliably be prevented from being cut.

The foregoing embodiments described with reference to the accompanying drawings are not restrictive but may be modified or expanded as follows. Although the cutting apparatus 1 has been applied to the cutting plotter in the foregoing embodiments, the cutting apparatus 1 may be applied to various types of apparatuses having respective cutting functions.

The detection unit should not be limited to the configuration employing the imaging member 59. The detection unit may be constituted by another image input unit capable of obtaining a color image, instead. Furthermore, the detection unit may be constituted by an image input unit capable of obtaining a monochrome image. Although not shown, the pattern selecting unit may include the display 9 and a touch panel mounted on the front of the display 9 and having a plurality of touch keys composed of a transparent electrode. In this case, when the touch key is operated by a finger of the user or depressed by a touch pen, whereby various parameters may be set and various functions may be instructed as well as selection of the pattern and the object 6.

The first and second storage units should not be limited to the external memory 64 but may be another inner storage unit incorporated in the cutting apparatus 1 or an external storage unit detachably attached to the cutting apparatus 1. The first to third informing units should not be limited to the display unit including the display 9 but may be configured to inform the user of reaffixing of a new object 6 and the like by activation of a buzzer or lighting of an alarm lamp. A loud speaker may be provided to produce a sound.

The arrangement setting program stored on the storage unit in the cutting apparatus 1 may be stored by a non-transitory computer readable storage medium such as a USB memory, CD-ROM, a flexible disc, DVD or a flash memory. In this case, the arrangement setting program may be loaded from the storage medium to a computer of each one of various apparatuses provided with a cutting function, whereby the same working and advantageous effects as those in the foregoing embodiments may be achieved.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting apparatus comprising:
a cutting unit which is configured to move a holding member set on the cutting apparatus and a cutting blade relative to each other thereby to cut a desired pattern out of at least one object to be cut, by the cutting blade, the holding member holding the object so that the object is removable therefrom;
a detection unit which is configured to detect information including a hold position of the object held by the holding member;
a pattern selecting unit which is configured to select a desirable one of a plurality of patterns;
an arrangement unit which sets an arrangement position of the pattern selected by the pattern selecting unit, relative to the object, based on the hold position of the object detected by the detection unit, wherein the pattern is cut off by the cutting unit with the arrangement position set by the arrangement unit serving as a cutting position of the object.

2. The cutting apparatus according to claim 1, further comprising a display unit, wherein when the arrangement position of the pattern has been set by the arrangement unit, the display unit displays the pattern while the pattern corresponds to the arrangement position.

3. The cutting apparatus according to claim 1, wherein the detection unit is configured to further detect a type of the object held by the holding member, the cutting apparatus further comprising:
a first storage unit which is configured to store cutting data used to cut each pattern selected by the pattern selecting unit and type data specifying a type of the object, the cutting data and the type data being correlated with each other for every pattern; and
a type determination unit which is configured to determine whether or not any type of the object correlated with the pattern is on the holding member,
wherein the arrangement unit is configured to set an arrangement position of the object of the type correlated with the pattern, based on a result of determination by the type determination unit; and
the cutting unit is configured to cut the pattern based on the cutting data and the arrangement position set by the arrangement unit.

4. The cutting apparatus according to claim 3, wherein the type data includes color data used to specify at least the object.

5. The cutting apparatus according to claim 3, further comprising a first informing unit which informs of the result of determination by the type determination unit.

6. The cutting apparatus according to claim 1, wherein the detection unit is configured to further detect information about an outline position of the object held by the holding member, the cutting apparatus further comprising:
a second storage unit which is configured to store cutting data used to cut each pattern, the cutting data including shape data corresponding to shapes of the patterns selected by the pattern selecting unit; and
a size determination unit which is configured to determine whether or not any object having a size corresponding to a shape of the pattern is on the holding member, based on the shape data read from the second storage unit and information about a position of outline of the object detected by the detection unit, regarding the pattern selected by the pattern selecting unit,
wherein the arrangement unit is configured to set an arrangement position of the object with the size corresponding to the shape of the pattern, based on a result of determination by the size determination unit; and
the cutting unit is configured to cut the pattern based on the cutting data and the arrangement position set by the arrangement unit.

7. The cutting apparatus according to claim 6, further comprising a second informing unit which informs of the result of determination by the size determination unit.

8. A non-transitory computer readable storage medium which stores a program used with a cutting apparatus including a cutting unit which is configured to move a holding member set on the cutting apparatus and a cutting blade relative to each other thereby to cut a desired pattern out of at least one object to be cut, by the cutting blade, the holding member holding the object so that the object is removable therefrom and a pattern selecting unit which is configured to select a desirable one of a plurality of patterns, the program comprising:
a detection routine of detecting information including a hold position of the object held by the holding member; and
an arrangement routine of setting an arrangement position of the pattern selected by the pattern selecting unit, relative to the object, based on the hold position of the object detected by the detection routine.

9. The storage medium according to claim 8, wherein the program further comprises a display routine wherein when the arrangement position of the pattern has been set by the arrangement routine, the display unit displays the pattern while the pattern corresponds to the arrangement position.

10. The storage medium according to claim 8, wherein:
the cutting apparatus further includes a first storage unit which is configured to store cutting data used to cut each pattern selected by the pattern selecting unit and type data specifying a type of the object, the cutting data and the type data being correlated with each other for every pattern;
in the detection routine, a type of the object held by the holding member is further detected;
the program further comprises a type determination routine of determining whether or not any object of a type correlated with the pattern is on the holding member; and
in the arrangement routine, the arrangement position is set for the object of the type correlated with the pattern, based on a result of determination in the type determination routine.

11. The storage medium according to claim 10, wherein the detection data includes color data used to specify at least a color of the object.

12. The storage medium according to claim 10, wherein the program further comprises a first informing routine of informing of the result of determination in the type determination routine.

13. The storage medium according to claim 8, wherein:
the cutting apparatus further includes a second storage unit which is configured to store cutting data used to cut each pattern, the cutting data including shape data corresponding to shapes of the patterns selected by the pattern selecting unit;
in the detection routine, information about an outline position of the object held by the holding member is further detected;
the program further comprises a size determination routine of determining whether or not any object having a size corresponding to a shape of the pattern is on the holding member, based on the shape data read from the second storage unit and information about a position of outline of the object detected in the detection routine, regarding the pattern selected by the pattern selecting unit; and
in the arrangement routine, an arrangement position is set for the object with the size corresponding to the shape of the pattern, based on a result of determination by the size determination unit.

14. The storage medium according to claim 13, wherein the program further comprises a second informing routine of informing of the result of determination in the size determination routine.
